(19) United States
(12) Patent Application Publication
(10) Pub. No.: US 2020/0183911 A1
(43) Pub. Date: Jun. 11, 2020

(54) DATA FILE INTEGRITY

(71) Applicant: MEDITECHSAFE, INC., West Chester, OH (US)

(72) Inventors: Pranav N. Patel, West Chester, OH (US); Sivakumar Kannathasan, Hamilton, OH (US)

(21) Appl. No.: 16/212,911

(22) Filed: Dec. 7, 2018

(51) Int. Cl. G06F 16/23

(52) U.S. Cl. CPC G06F 16/2365

(57) ABSTRACT

A process for user-based validation of data accuracy is disclosed. The process includes receiving a log-on from a first user having a first user role. The process further includes selecting a data value from an information profile based on the first determined user role. The process includes selecting a first question, which represents a value to be entered into the selected data value. Yet further, the process includes presenting the selected first question to the first user. In addition, the process includes receiving a first answer from the first user. The process further includes storing the first answer. The process also includes repeating the above recitations (receive log-in, select data value, select question, present question, receive answer, and store answer) for a second user. Moreover, the process includes comparing the stored first answer against the stored second answer and updating the data value profile based on the comparison.

### BACKGROUND

Various aspects of the present disclosure relate generally to maintaining integrity of data files, and more particularly to using user-based incentive crowdsourcing to maintain integrity of data files.

Data systems, including data analytics in relation to the data systems, are in some cases highly dependent on accuracy of data within the data systems due to potential consequences of acting on inaccurate or incomplete data. Accordingly, entities that are susceptible to those potential consequences may implement additional safeguards and processes to ensure data integrity.

### BRIEF SUMMARY

According to aspects of the present disclosure, a process for user-based validation of data accuracy is disclosed. The process includes assessing a data source, the data source having a collection of information profiles. In this regard, each information profile has a confidence rating assigned thereto, which characterizes a confidence in at least one of the completeness and accuracy of the data stored in the information profile. Further, the process involves selecting an information profile (e.g., by process, or by input by a user). The process also includes transmitting to a first processing unit (e.g., mobile device), a first solicitation for feedback, where the first solicitation is generated based upon a first requirement to update the selected information profile, and a second requirement to update the associated confidence rating. The process further includes receiving the first feedback from the first processing unit.

Moreover, the process involves transmitting to a second processing unit, a second solicitation for feedback, where the second solicitation is generated based upon the first requirement to update the selected information profile, and the second requirement to update the associated confidence rating. Further the process includes receiving the second feedback from the second processing unit.

In addition, the process includes comparing the first feedback to the second feedback. Moreover, the process involves modifying a data value within a data value of the selected information profile, where there is agreement between the first feedback and the second feedback, with a data value derived from the first feedback and the second feedback. Also, the process includes computing an updated confidence rating based upon the first feedback and the second feedback.

Further according to aspects of the present disclosure, a process for user-based validation of data accuracy is disclosed. The process includes accessing a data source, the data source having a collection of information profiles. In this regard, each information profile has a confidence rating assigned thereto, which characterizes a confidence in at least one of the completeness and accuracy of the data stored in the information profile. Further, the process involves selecting a data value from the information profile based upon the confidence rating of the selected information profile (e.g., by process, or by input by a user). The process also includes transmitting to a first processing unit, a first solicitation for feedback, where the first solicitation is generated based upon the selected data value. The process further includes receiving the first feedback from the first processing unit.

Moreover, the process involves transmitting to a second processing unit, a second solicitation for feedback, where the second solicitation is generated based upon the selected data value. Further the process includes receiving the second feedback from the second processing unit.

In addition, the process includes comparing the first feedback to the second feedback. Moreover, the process involves modifying the selected data value, where there is agreement between the first feedback and the second feedback, with a data value derived from the first feedback and the second feedback. Also, the process includes computing an updated confidence rating based upon the first feedback and the second feedback.

Further according to aspects of the present disclosure, a process for user-based validation of data accuracy is disclosed. The process includes performing, cyclically until a predetermined number of answers have been stored, a predefined series of actions. The series of actions include receiving a log-on from a user from a device, wherein the user has a determined user role. The series of actions also include selecting a data value from a prioritized information profile associated with a first device, based on the first determined user role. Moreover, the series of actions entail selecting a question that solicits an answer, which represents a value to be entered into the selected data value. Further, the series of actions include receiving an answer to the question by the user, and storing the answer.

Once the predetermined number of answers is met, the process includes comparing, upon reaching the predetermined number of answers (which is highly variable based on numerous factors as described herein), the stored answers against one another. Also, the process includes updating the information profile based on the comparison.

### BRIEF DESCRIPTION OF THE SEVERAL VIEWS OF THE DRAWINGS

FIG. 1 illustrates an example of a network according to aspects of the present disclosure;

FIG. 2 illustrates an example architecture of a processing unit according to aspects of the present disclosure;

FIG. 3 illustrates a process for user-based validation of data accuracy according to aspects of the present disclosure;

FIG. 4 illustrates an example information profile according to aspects of the present disclosure;

FIG. 5A-5E illustrate an example of a user experience during various processes and systems herein according to aspects of the present disclosure;

FIG. 6 illustrates a comparison of an information profile before and after data values are updated according to aspects of the present disclosure;

FIG. 7 illustrates an example workflow of how answers from various users are validated, including modifying metrics (e.g., scores/points) of various users according to aspects of the present disclosure;

FIG. 8 further illustrates another example workflow of how answers from various users are validated, including modifying metrics (i.e., scores/points) of various users according to aspects of the present disclosure;

FIG. 9 illustrates another embodiment for a process for user-based validation of data accuracy according to aspects of the present disclosure; and

FIG. 10 illustrates yet another embodiment for a process for user-based validation of data accuracy according to aspects of the present disclosure.

### DETAILED DESCRIPTION

Introduction

Aspects of the present disclosure provide for incentive-based data gathering, data validation, and data integrity mechanisms using crowdsourcing (e.g., gamification), more specifically intrinsic and extrinsic incentive-based crowdsourcing (hereinafter “incentive-based crowdsourcing”). By using incentive-based crowdsourcing, data integrity can be established and validated quickly and reliably.

As described in greater detail herein, data can be embodied as a data set (or data source) that is within a digital structure such as a traditional hardware database, binary large object (BLOB) storage, remote (“cloud”) storage, representational state transfer (REST) storage, etc. Alternatively, or even simultaneously, data can be associated with (or embodied within) a physical device such as data reflecting hardware specifications (number of universal serial buses (USB ports), operating system version, etc.), for example.

From a practical standpoint, nearly every entity including corporations, associations, small businesses, independent contractors, and individuals rely on data. Generally, the more technologically driven an entity is, the more that entity relies on accuracy and integrity of data.

As a result, such entities and associated data can be susceptible to vulnerabilities or other negative consequences associated with inaccurate data. Notably, the effects of inaccurate data can become more pronounced when the entity houses sensitive data such as financial records or health records. Further, the introduction of devices that connect to the internet via a network (i.e., internet of things (IoT) devices) can further compound an amount of raw data an entity may have to process in order to ensure the integrity of the data.

Moreover, devices may require regular updates or maintenance in order to run efficiently and reliably. However, the sheer number of devices can make a seemingly simple task (i.e. update and maintain data) become overwhelming. In this regard, depending on the device, failure to update and maintain the data associated with the device can range from virtually no risk to appreciable risk.

While many devices are connectable to a network, those devices are not always connected. Furthermore, some devices are mobile, which means that those devices can get connected on different network/subnetwork connections at different times. Thus, network-wide scans and updates may not be effective in locating devices and accessing data.

As noted above, data integrity in any big data, data analytics based application, etc. can be crucial. Thus, the present disclosure is directed toward processes and systems that bolster data integrity, leading to improved accuracy for data analytics and processing.

Further, aspects of the present disclosure are directed toward user-based validation of data accuracy and integrity. By implementing incentive-based crowdsourcing (e.g., “gamification”) as described herein, data across nearly all industries can be gathered, updated, and validated in a manner that is far more efficient and accurate than tradition data gathering and integrity solutions regardless of whether a network connection is present.

In this regard, aspects of the present disclosure utilize an unconventional approach of confidence ratings and prioritization modifiers to sort, select, and solicit data sets (e.g., information profiles) for implementation of the processes herein.

Moreover, the disclosure herein improves technologies of data gathering, data validation, and data integrity that can be applied to a wide range of data, data storage solutions, devices, components within the devices, and data associated therewith regardless of whether a network connection is present.

System Overview

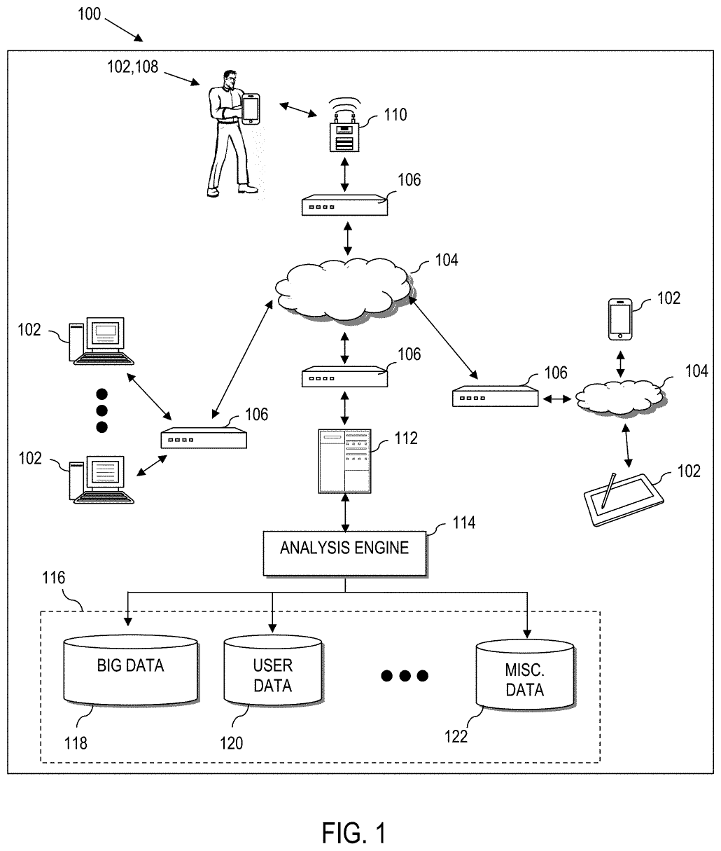

Referring now to the drawings and in particular to FIG. 1, a general diagram of a system 100 is illustrated according to various aspects of the present disclosure. The illustrated system 100 is a special purpose (particular) computing environment that includes a plurality of hardware processing units (designated generally by the reference 102) that are linked together by one or more network(s) (designated generally by the reference 104).

The network(s) 104 provides communications links between the various processing units 102 and may be supported by networking components 106 that interconnect the processing units 102, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 104 may comprise connections using one or more intranets, extranets, local area networks (LAN), wide area networks (WAN), wireless networks (WiFi), the Internet, including the world wide web, cellular and/or other arrangements for enabling communication between the processing units 102, in either real time or otherwise (e.g., via time shifting, batch processing, etc.).

A processing unit 102 can be implemented as a server, personal computer, laptop computer, netbook computer, purpose-driven appliance, special purpose computing device and/or other device capable of communicating over the network 104. Other types of processing units 102 include for example, personal data assistant (PDA) processors, palm computers, cellular devices including cellular mobile telephones and smart telephones, tablet computers, an electronic control unit (ECU), a display of the industrial vehicle, a multi-mode industrial management badge, etc.

Still further, a processing unit 102 can be used by one or more users 108 (noting that the user is not a component of the network itself. In the example configuration illustrated, the various components herein can wirelessly communicate through one or more access points 110 to a corresponding networking component 106, which serves as a connection to the network(s) 104. Alternatively, the users 108 operating processing units 102 equipped with WiFi, cellular or other suitable technology allows the processing unit 102 to communicate directly with a processing unit (e.g., over the network(s) 104).

The illustrative system 100 also includes a processing unit implemented as a server 112 (e.g., a web server, file server, and/or other processing unit) that supports an analysis engine 114 and corresponding data sources (collectively identified as data sources 116).

In an exemplary implementation, the data sources 116 include a collection of databases that store various types of information related to an operation (e.g., a warehouse, distribution center, retail store, manufacturer, hospitals, data farms, cloud service stations, etc.). However, these data sources 116 need not be co-located. In the illustrative example, the data sources 116 include databases that tie processes executing for the benefit of the enterprise, from multiple, different domains. In the illustrated example, data sources 116 include an a “BIG DATA” database 118 (housing data for various industries), a user data system (e.g., for user specific data such as user types, user roles, etc. as disclosed in greater detail herein) 120, and a miscellaneous data storage 122 (e.g., storage specific to industry, programs and platforms that interact with other databases and systems, programs, modules, etc.). The above list is not exhaustive and is intended to be illustrative only.

Example Processing Unit

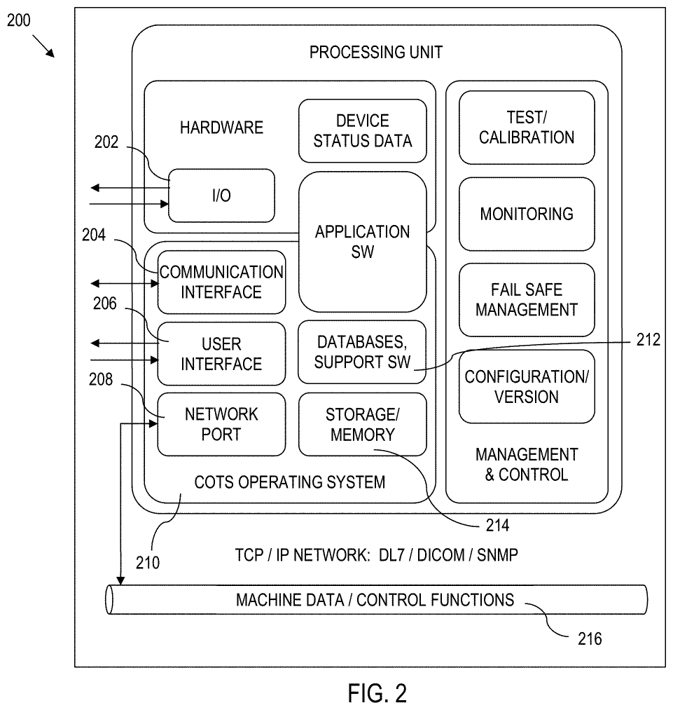

For illustrative purposes, an example processing unit architecture 200 (see also reference number 102 in FIG. 1) is shown in FIG. 2. The processing unit architecture 200 has various components such as input/output (I/O) ports 202, communication interfaces 204, user interfaces, 206, network ports 208, operating systems 210, database support software 212, storage/memory 214, and management/control functions 216.

User-Based Validation of Data Accuracy

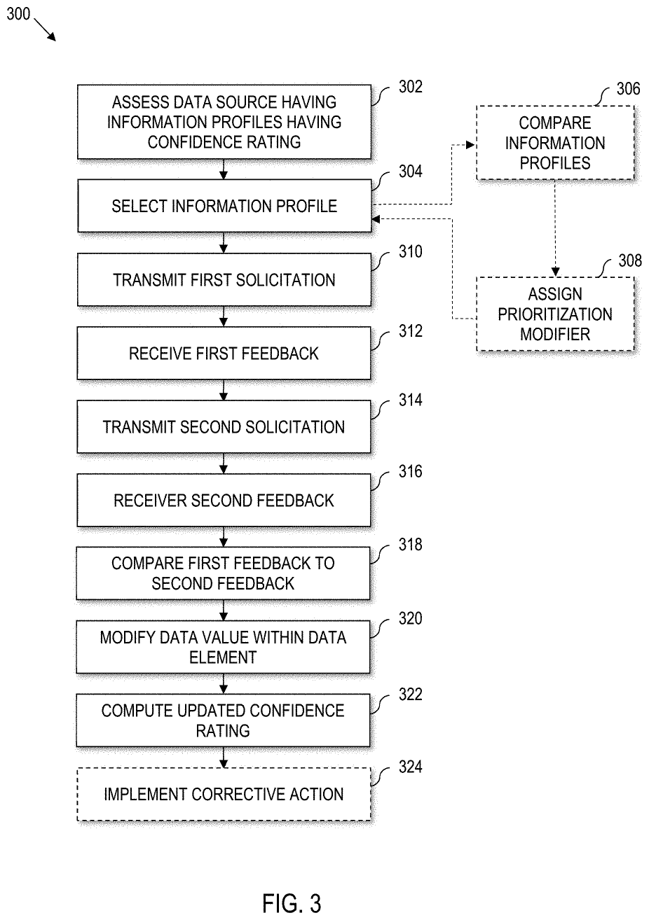

Now to FIG. 3, a process 300 for user-based validation of data accuracy is disclosed. The process 300 comprises assessing at 302 a data source, the data source having a collection of information profiles, each information profile having a confidence rating assigned thereto, wherein the confidence rating is at least one of the completeness and accuracy of the data stored in the information profile (i.e., the confidence is characterized by completeness of the data stored in the information profile and/or accuracy of the data stored in the information profile). In various embodiments, the process 300 comprises generating, for each information profile, a corresponding confidence rating. Confidence and confidence ratings are described in greater detail herein.

Further, the process 300 comprises selecting at 304 an information profile. Information profiles, as used in the process 300 as detailed herein, comprise a wide variety of subject matter across multiple industries including, but not limited to hardware (e.g., medical devices, consumer electronics, etc.), software (e.g., operating systems, stand-alone software, etc.), and data records/archives.

For example, information profiles can be templates with predetermined data values that users can add to or contribute to under various aspects of the present disclosure. As used herein, information profiles generally comprise data that is specific to that particular item/device/data set/etc. Information profiles can be comprised of data elements and data values. Data elements are subsets of the information profile, and data values are subsets of the data element.

For example, in a database of cars, each individual car has its own information profile. Data elements within the information profile may be components or features of a car (e.g., power windows, turbo charger, horsepower, etc.). Data values within the data elements may be information for each data element (e.g., “yes” for power windows, “400 HP” for horsepower, etc.).

In the context of devices as disclosed in greater detail herein, information profiles typically delineate between product level information and asset level information in their respective data elements and data values.

Product level information comprises general information that is consistent across an industry or a particular model/version of a product/device. Examples of product level information include a type of device description, manufacturer, hardware specifications (e.g., processor, type of RAM, amount of RAM used, etc.), a number of access ports, networking capabilities, ability to store data (e.g., personal health information), encryption capability, etc. (i.e., information that is universal across multiple unique devices sharing the same model number). Further, product level information may also be gathered from a variety of sources such as using a web-scraper to scrape a data source.

Asset level information comprises information that is generally specific to a given product/device/item/data set/etc. (hereinafter “device” for simplicity) within particular group or model number. Asset level information can include a serial number of the device, a manufactured date for the device, whether or not the device is connected to a network (and how it is connected, wired, wireless, etc.), whether or not the device is currently powered on or off, whether or not there are exposed universal serial bus (USB) ports, software version that is currently installed on the device, etc.

For clarity, it is possible that information or data can be categorized as both product level and asset level information. Moreover, expansion or changes of capabilities of a given device may affect both product and asset level information. For example, supported operating systems on a scanning machine may be initially restricted to “operating system A” and “operating system B”, which could be categorized as product level information. Simultaneously, at the asset level, the scanning machine may be running operating system B. This example is by way of illustration and is in no way limiting.

In various embodiments, product level information can be comprised of non-modifiable data, and asset level information can be comprised of modifiable data. Also, product level information can be comprised of non-variable data, and asset level information can be comprised of variable data.

With respect to selecting 304 the information profile, various embodiments of the process 300 comprise prioritizing at 306 an information profile, wherein prioritizing an information profile comprises comparing at 306 data elements and associated data values of at least two information profiles within the collection of information profiles and assigning at 308 a prioritization modifier to at least one of the compared information profiles based on at least one of the calculated confidence rating, a completeness of the information profile, and a need-based modifier (i.e., based on the confidence rating, a completeness of the information profile instance, a need-based modifier, or a combination thereof) as described herein.

In various embodiments, completeness of the information profile inversely corresponds to the prioritization modifier. Typically, a more “complete” information profile has fewer unknown variables (i.e., blank data values), which is likely to increase the confidence rating. Conversely, a less complete information profile is likely to decrease the confidence rating, thus resulting in a higher prioritization modifier for that information profile.

The need-based modifier can be influenced by a variety of factors. While the need-based modifier can be based off of or associated with the completeness of the information profile and/or the confidence rating, the need-based modifier can also be independently set based on a preference. For example, if a new product is released into an environment, an administrator may apply adjust the need-based modifier to influence the new product to move toward the top of a result list, thus increasing a rate at which information is collected for the new product by users.

In multiple embodiments, the process 300 comprises assigning an additional weighted modifier based previous activity (or trend) of a user on the user platform. For instance, if the user tends to favor radiofrequency identification (RFID) transmitters, the additional weighted modifier can make results for RFID transmitters more prevalent.

Prioritization can also have an influence on users from an incentive/scoring standpoint. For example, devices that are “lost” (e.g., insufficient record of a last known location) may be worth additional points (e.g., ten points) if found by the user. Further, devices that have a lower confidence rating due to missing data (e.g., blank data values, or filled data values that are old) may be worth additional points (e.g., twenty points) if scanned and/or questions about the device are answered. These bonuses add surprise or random element to the user platform that incentivizes participation from the users.

In various embodiments, the information profile can be selected externally. For example, in various embodiments, the process 300 comprises selecting the information profile based on a received input from a user. For example, the user may wirelessly communicate with a device using a mobile device (e.g., Bluetooth®, owned by Bluetooth SIG, located at 5209 Lake Washington Blvd NE Suite 350 Kirkland, Wash. 98033 USA). The user can then transmit the device (including its associated information profile and data values) to aspects of the process 300.

Moreover, the process 300 comprises transmitting at 310 to a first processing unit (see reference number 102 in FIG. 1), a first solicitation for feedback, where the first solicitation is generated based upon a first requirement to update the selected information profile and a second requirement to update the associated confidence rating.

In an illustrative example, the transmitted solicitation is received by the first processing unit and displayed to a first user. In various embodiments, the solicitation is in a form of a question directed toward the data value within the information profile. In an example of an information profile for a surgical laser, questions may include:

What is the serial number of the device?

Is the device currently connected to a network?

What is the lens diameter?

Is this device a class 1, class 2, or class 3 device?

Thus, in various embodiments, transmitting to the first processing unit a first solicitation for feedback comprises receiving a log-on from a first user from a first processing unit, wherein the first user has a first determined user role, selecting a data value from the information profile based on the first determined user role, selecting a first question that solicits an answer, which represents a value to be entered into the selected data value and transmitting the selected first question to a first graphic user interface of the first processing unit operated by the first user. In various embodiments, the first determined user role can influence the solicitation as described in greater detail herein.

Further, the process 300 comprises receiving at 312 the first feedback from the first processing unit, which is described in greater detail herein.

Yet further, the process 300 comprises transmitting at 314 to a second processing unit, a second solicitation for feedback, where the second solicitation is generated based upon the first requirement to update the selected information profile, and the second requirement to update the associated confidence rating. In various embodiments, the second solicited feedback can be the same as, or different than, the first solicited. For example, when feedback is in the form of a question, a first question and a second question may be phrased slightly different from one another to account for potential biases of the respective users (or account for preferences in terminology, etc.).

Thus, in various embodiments, transmitting to the second processing unit a second solicitation for feedback comprises receiving a log-on from a second user from a second processing unit, wherein the second user has a second determined user role, selecting a data value from the information profile based on the second determined user role, selecting a second question that solicits an answer, which represents a value to be entered into the selected data value and transmitting the selected second question to a second graphic user interface of the second processing unit operated by the second user. In various embodiments, the second determined user role can influence the solicitation as described in greater detail herein. In various embodiments, the first user and the second user do not know each other.

In addition, the process 300 comprises receiving at 316 feedback from the second processing unit.

Moreover, the process 300 comprises comparing at 318 the first feedback to the second feedback. In various embodiments, the process 300 solicits more than two feedback(s) for a higher degree of confidence, as well as enabling the process to use more complex comparison techniques.

In multiple embodiments, the received feedback(s) are compared to find a common or consistent feedback (which indicates that the feedback is more likely to be accurate or correct). Feedback can be compared using various mechanisms such as averages, simple majority, weighted based on the user that submitted the answer(s), or combinations thereof.

When using averages, for example, if 70% is a threshold value that determines which feedback is consistent or “correct”, the process 300 may solicit and receive feedback(s) until 70% of the feedback(s) are consistent (e.g., both feedback(s) agree, three out of four feedback(s) agree, seven out of ten feedback(s) agree, etc.). In this regard, the process 300 may have a minimum number of feedback(s) that must be received before a comparison to determine average (e.g., minimum of ten received feedback(s)).

Alternatively, in a simple majority, the process 300 may continue to solicit and receive feedback(s) until a majority of the feedback(s) are consistent (e.g., two out of three feedback(s) agree, three out of four feedback(s) agree, six out of ten feedback(s) agree, etc.). In this regard, the process 300 may have a minimum number of feedback(s) that must be received before a comparison to determine consistency (e.g., minimum of ten received feedback(s)).

Still referring to FIG. 3, the process 300 comprises modifying at 320 a data value within a data element of the selected information profile, where there is agreement between the first feedback and the second feedback, with a data value derived from the first feedback and the second feedback.

In addition, the process 300 comprises computing at 322 an updated confidence rating based upon the first feedback and the second feedback. Once an agreement is reached, the data value is updated. If the data value was blank, the feedback will fill in the blank. If the data value had a pre-existing value, the pre-existing value is replaced.

In various embodiments, the process 300 may comprise implementing at 324 a corrective action when the first feedback and the second feedback do not agree. Corrective actions can include, but are not limited to, issuing an alert to a pre-determined third party, quarantining the information profile, re-soliciting feedback, etc.

Generally, the process 300 can be implemented via a user platform, which may be centralized in a designated location(s) (e.g., a local network such as 106 in FIG. 1) or implemented remotely (e.g., on a server such as 112 in FIG. 1).

The user platform allows designated parties (e.g., a network administrator) to create or access user profiles, which comprise a wide variety of fields including a user name, a user role (e.g., a profession, a particular user group, etc.), a user rank or user level within the user platform, a user history, etc.

Further, user platforms as noted herein may be divided or delineated at a company level (e.g., company A vs company B), department level (e.g., engineering vs sales, technicians vs clinicians, etc.), sub-department level (chemical engineers vs electrical engineers), or personal level (civilian, military, etc.).

In various embodiments, a role of the user can be a basis for selecting an information profile and associated data value. In this regard, user role can dictate whether product level data values, asset level data values, or a combination thereof are chosen. For example, a user with a user role that does not have access to individual devices may be restricted to product level data values and information since product level information is generally accessible to the broad public (e.g., consumers). However, a user with a user role that does have access to individual devices (e.g., equipment technician) may have access to asset level data values and information as well.

In addition to user role, selection of a data value from an information profile can be based on other factors, or even prioritized over other data values as described in greater detail below.

Moreover, user role can also influence the type of feedback solicited by aspects of the process 300. For example, when feedback is solicited in the form of questions, questions can range in difficulty from low/to intermediate/to advanced. Thus, user role can also be a factor to determine which questions (including how difficult the questions are) are selected.

For example, a user having the user role of a receptionist is not likely to know what the media access control (MAC) address on a particular device is. Thus, questions relating to MAC addresses are less likely to be selected for the receptionist. Conversely, a network administrator is likely to know the MAC address, thus questions relating to MAC addresses are more likely to be selected for the network administrator.

Incentives for Data Validation and Integrity Users

Data validation and integrity through the use of users, while effective, requires both time and some degree of work from the users. Thus, an incentive structure to encourage ongoing participation from the users can be an effective tool. For ease of understanding, the feedback herein is an answer to a question.

In multiple embodiments of the processes and systems herein, a user platform is implemented (e.g., an application or “app”). The user platform allows designated parties to create or access user profiles, which comprise a wide variety of metrics including a user name, a user role (e.g., a profession, a particular user group, etc.), a user rank/level within the user platform or user role, a user history, etc.

For example, a healthcare facility (e.g., hospital) through the user platform can designate each employee as a user. Like users (e.g., physicians, lab technicians, etc.) can be grouped together. Within these groups, a hierarchy or level based structure can be implemented. For example, every user within a group may start at level one (1).

In various embodiments, each time a user answers a question correctly, that user is awarded “points” as a reward. For instance, as a base level of scoring, if a user correctly answers a question, the correct answer is worth three points. Subsequent answers (i.e., validations) that confirm the correct answer are worth two points, and validations that conflict with the correct answer are worth negative three (−3) points. Once a level one user gains enough points, the level one user becomes a level two user. How and when points are awarded are described in greater detail herein.

Adding a further level of depth, user level can have an impact on scoring and points. For example, a level two user still gains and loses points as described above, but has a scoring weight applied for incorrect or inconsistent answers. Whereas a level one user loses three points for an incorrect answer (e.g., bad validation), the level two user loses four points. Further, the scoring weight may be even higher for a level three user, which loses five points for an incorrect answer.

In various embodiments, the scoring weight may also apply to correct answers and validations as well, thus rewarding higher level users for their contributions and effort in achieving higher levels. In multiple embodiments, higher user levels have additional benefits. For example, higher user levels may be published or given special recognition within a user group/role, recognition across specified industries, or user level may be used to convey expertise or productivity to employers and colleagues.

Additional scoring mechanics can be utilized as well. For instance, users may be able to receive a chain bonus for answering multiple questions in a row. In one example, a user may receive a chain bonus of one point for every five questions that the user answers. The chain bonus can also be influenced by user level as well, such as a level three user getting three points for every five answers that the level three user answers, etc.

Yet another scoring mechanic that may be used is taking a picture of the device that the user is answering the questions about. Users may be scored for “taking the first photo”, rating an existing photo, or taking a new photo in hopes that the new photo becomes popular enough to supplant the first photo on a leader board, thus encouraging friendly competition and participation. Point values associated with each activity can vary.

In certain implementations, the user level may dictate which questions are selected for that particular user. For example, while the user role may indicate that a user has the expertise to answer a question, the certain questions may be reserved for higher level users. Questions reserved for high level users may be about a critical feature of the device, or if there are adverse consequences for incorrect information. For example, questions may be separated or delineated into easy, intermediate, and advanced questions.

In this regard, processes and systems herein may comprise accessing a user profile from the user platform, wherein the user profile comprises a user level, comparing known values associated with the information profile against the user level, and filtering out questions that are determined to exceed a capability of the user based on the comparison.

Further, questions can be selected based on factors such as the user history. For example, if the user tends to submit information regularly in the field of hydraulic machines, questions that are selected for the user may be weighted toward hydraulic machines.

Thus, based on the above, in various embodiments of the processes and systems herein, the process further comprises modifying a user metric (e.g., user score or user points) of at least one of the first user and the second user based on the comparison of the stored first answer against the stored second answer. In such embodiments, the process comprises retrieving a user baseline score from at least one of the first user and the second user, applying a positive score to the user baseline score of at least one of the first user and the second user if the first answer and the second answer are correct, and applying a negative score to the user baseline score of at least one of the first user and the second user if the first answer and the second answer are incorrect.

Moreover, in various embodiments a majority threshold may be used to compare answers, but answers may be given a greater or lesser weight depending on the user that submitted the answer. For example, answers from high level users (as described in further detail herein) may be given a larger weight than lower level users.

Example Information Profile

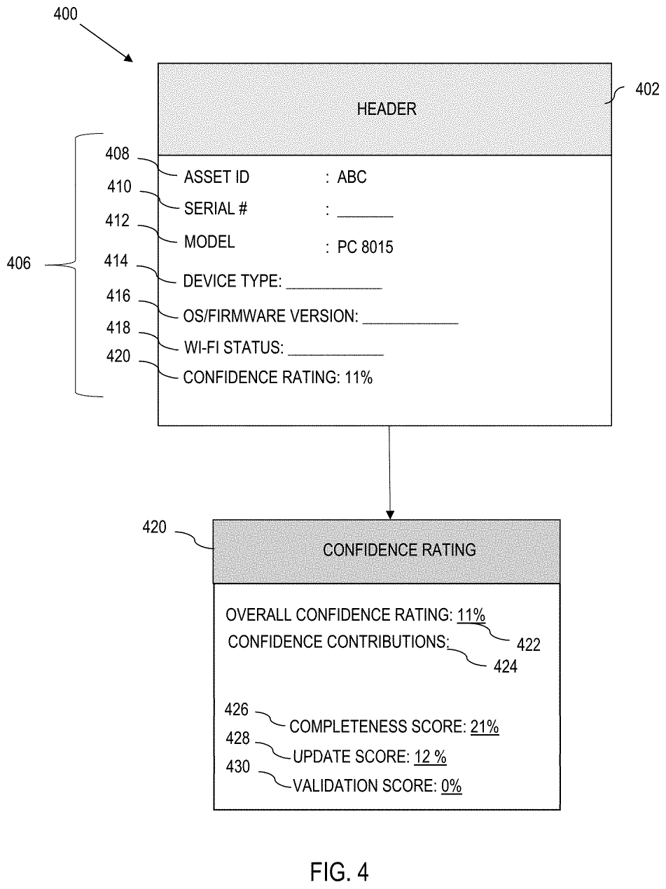

FIG. 4 illustrates an example information profile 400 that may be used with the various processes herein. The information profile 400 may encapsulate data that is purely in digital form on a server, or the information profile 400 may encapsulate data that is associated with a device/product.

Further, the information profile may exist in digital form only (e.g., back end), or may be displayed on a processing unit (e.g., mobile device). As noted herein, the information profile 400 can comprises a header 402 (e.g., location, type of data or device, etc.) as well as multiple data values 406 that can be product level or asset level data values 406. Example data values include asset id 408, serial number 410, model number 412, device type 414, OS/firmware version 416, Wi-Fi (or other connectivity) status 418, and confidence rating 420. For context, reference numbers 408-420 are data elements, while information associated with those data elements are data values (e.g., “ABC” is the data value for ASSET ID 408).

FIG. 4 also illustrates the confidence rating 420 in further detail. In multiple embodiments, the confidence rating 420 is expressed as an overall confidence rating 422. The overall confidence rating is based on confidence contributions 424 such as a completeness score 426, an update score 428, and a validation score 430.

Generally, the completeness score 426 relates to how complete the information profile 400 is. In this regard, the fewer the number of completed data values, the lower the completeness score 428 (and hence a low confidence rating as well).

The update score 430 generally relates to time elapsed since information within the information profile has been updated. Even if a particular data value is complete, the particular data value may be out of date in a matter of hours, days, weeks, etc. (e.g., how a particular device is connected to the network, which may change day-to-day in the case of connection of a wireless connection to a network). Thus, certain data values may require constant updates to maintain a high overall confidence rating 422.

The validation score 430 score looks to the data values and determines how many times the data values have been validated, how consistent the validations are, etc. by one or more people or by a designated expert. As noted herein, validations/answers increase the likelihood that that data values are filled with valid/good information, thus providing a higher confidence rating 420.

The completeness score, update score, and validation may be weighted equally, or variable based on preference as described in greater detail herein.

Example User Experience

The following is an example of a user experience during various processes (e.g., the process 300) herein as a process. Further, while the following example user experience is directed toward interactions with a device for simplicity and clarity purposes, the processes and implementations are not limited as such, and may be used in broader applications (e.g., big data).

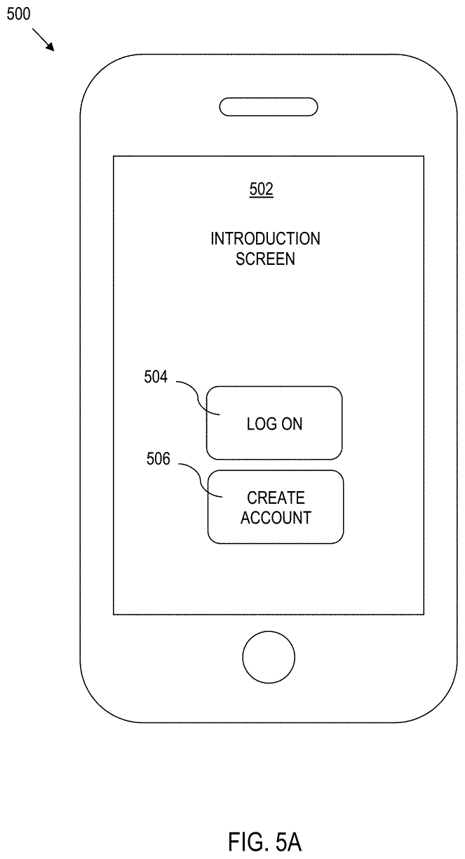

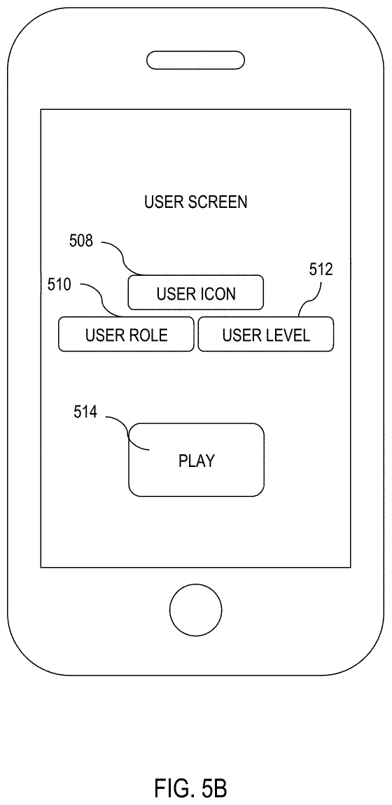

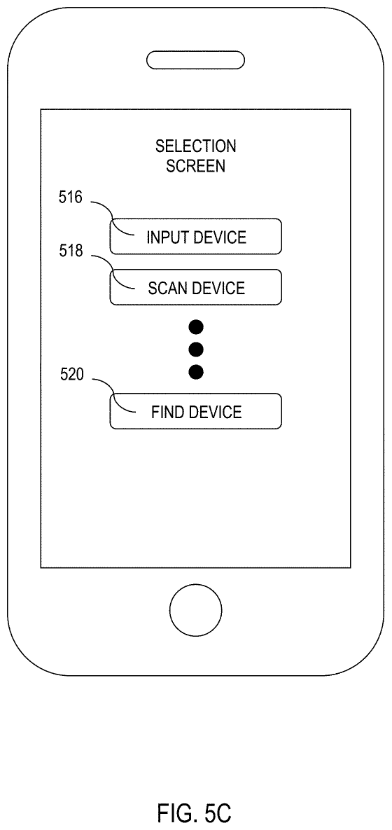

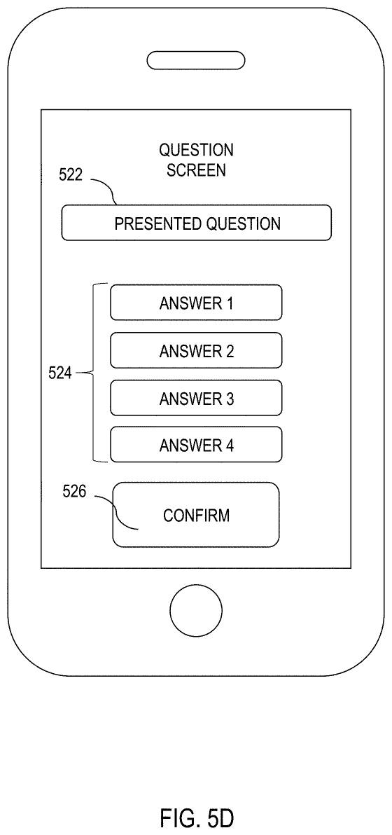

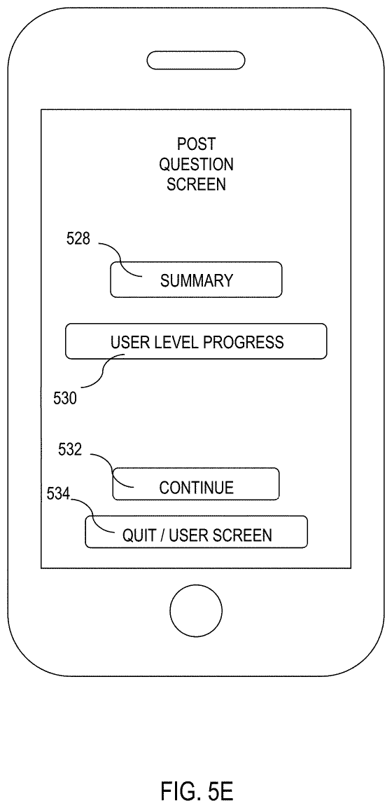

Referring to the figures, and in particular FIG. 5A, illustrates a mobile device 500 (see processing unit, reference number 102 in FIG. 1) having a display 502 that is displaying an introduction screen. In this example, the introduction screen has a selection for logging on 504 to the user platform for users that have an existing user profile. Users without an existing user profile can use a selection for creating an account 506 on to the user platform. These selections are by way of example, and by no means are limiting.

In FIG. 5B, once the user has logged on, a user screen displays a user icon 508 (e.g., a picture of the user, an avatar of the user, or any custom image or text that a user may want to use), a user role 510, and a user level 512. The user, when ready to proceed, can select play 514 to participate in the process.

In FIG. 5C, a selection screen presents multiple options that the user may select from to find, or interact with a device. Users can select an input device 516 option where the user can manually enter a device, which includes information profiles and associated data values, into the user platform.

For example, a user might walk by a device and decide manually enter an asset ID or serial number of the device into the user platform. Further, the user may select a scan 518 option and interact with a device. Examples include scanning a barcode on the device, taking a picture of the device and using image recognition, using Bluetooth (or other wireless protocols), etcetera. Users may also select find device 520, which can populate a list of devices based on a variety of filters or metrics (e.g., top 50 devices with a low confidence rating, a lost device, etc.).

In FIG. 5D, a question screen presents a question 522 (e.g., transmit first solicitation at 310 in FIG. 3) along with potential answers. In this example, four answers 524 are available. While four answers are shown in this example, there may be more or fewer than four answers. Further, questions may be in other formats such as true/false, multiple selection, fill-in, etc.

Once the user has selected an answer(s), the user selects confirm 526 to submit the answer (e.g., receiving feedback at 312 in FIG. 3). In various embodiments, multiple questions or sets of questions may be presented as described in greater detail herein.

FIG. 5E illustrates a post question screen that displays a summary 528. The summary 528 can include, but is not limited to a number of questions asked, number of questions answered, calculation of points earned, comparative statistics that compare the user to other users that have answered similar questions, etc. In various embodiments, a user level progress indicator 530 is displayed. The post question screen may also have a selection to continue answering questions 532, a selection to quit 534 (or go to back to the user screen), or both.

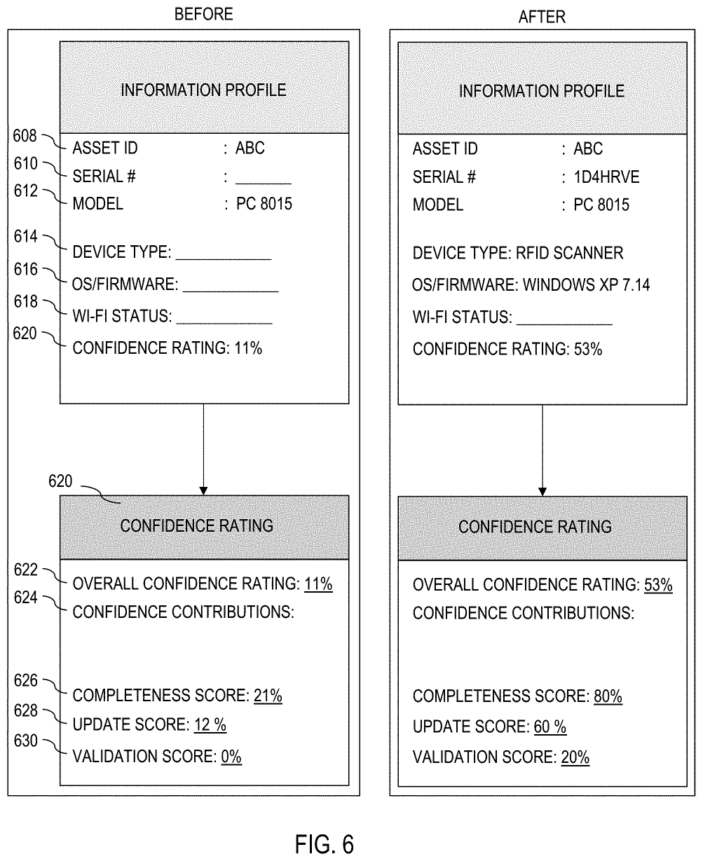

Once enough answers have been gathered and verified as disclosed in greater detail herein, the answers are used to update data values. For further illustration, FIG. 6 is a comparison of an information profile before and after data values are updated. The reference numbers in FIG. 6 are the same as the reference numbers in FIG. 4, except that the reference numbers in FIG. 6 are 200 higher.

In this example, users have answered and verified questions relating to serial number 610, device type 614, and OS/firmware version 616. Accordingly, the data values for serial number 610, device type 614, and OS/firmware version 616 are updated. As a result of the updated data values, the confidence rating 620 goes from 11% to 53% since the completeness score 626 increased from 21% to 80%, the update score 628 increased from 12% to 60%, and validation score 630 increased from 0% to 20%.

Feedback, Validation, and User Scores

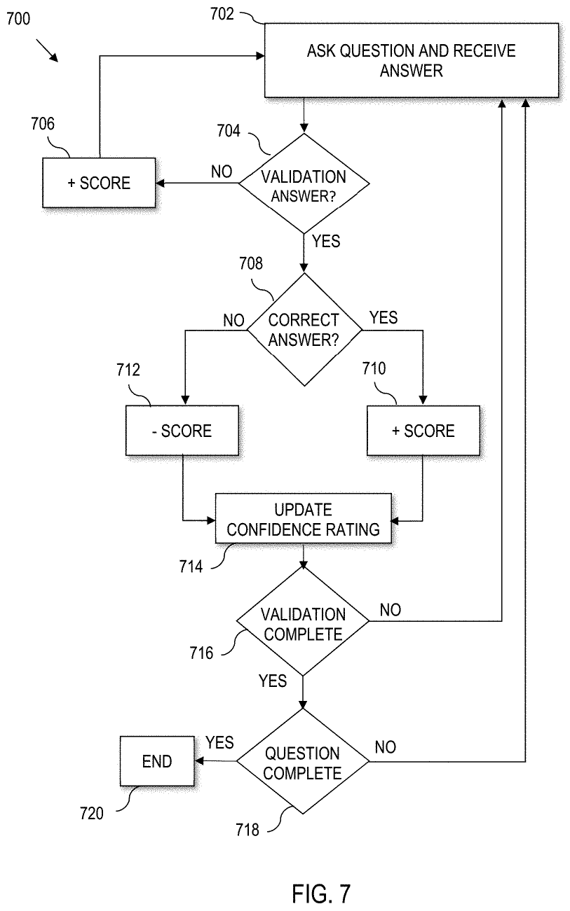

FIG. 7 is a flow chart 700 that illustrates an example workflow of how feedback from various users are validated, including modifying metrics (i.e., scores/points) of various users as described herein. In this flow chart 700, user metrics are score based, which can be positive in value or negative in value based on whether or not feedback is accurate.

For the following example workflow, answer and feedback are used synonymously for clarity.

In this example, a first user is presented a question, and the question is answered at 702. At 704, if this is the first time the question has been asked, then it is not a validation answer. Thus, at 706 the first user is given a positive score and the flow chart 700 resets to 702.

Thereafter, a second user answers the same question as the first user. The answer by the second user is received at 702. Now at 704, since this is the second time the question has been asked, the answer is considered a validation answer. The answer from the first user and the second user are compared at 708. If the answers are correct (or at least consistent, which indicates correctness), then the first and/or second user are given a positive score at 710.

If there is a conflict between the answers (indicating that at least one user is incorrect), then a few actions are possible. In one example, both users are given a negative score at 712 until a third answer corroborates the first answer or the second answer, wherein the corroborated answer gets a positive score, and the user that submitted the non-corroborated answer is given a negative score.

In another example, neither user is scored until a third answer corroborates the first answer or the second answer, wherein the corroborated answer gets a positive score, and the other answer is given a negative score. In an event where the first answer, second answer, and third answer are inconsistent, an independent party (e.g., administrator, technician, etc.) may be used to resolve the inconsistency as a fourth answer (feedback).

Thereafter, a confidence score that is associated with the question and answer(s) is updated at 714, and a validation check is initiated at 716. The validation check in multiple embodiments is a threshold of answers/validations that triggers one or more actions such as ending the question, which can set by the administrator or industry as a whole. In various embodiments, a question may require three consistent answers (i.e., validations) to be deemed complete.

If the threshold at 716 is not met, then the flow chart 700 resets to 702. If the threshold at 716 is met, then a question check is initiated at 718. The question check 718 determines whether or not the question needs to be periodically updated (e.g., product level information vs asset level information as described above). For example, a serial number for a particular device typically does not change. Therefore, once the serial number is validated, that question is no longer necessary. In such a case, the question can be removed or deactivated, and the flow chart moves to the end at 720. Alternatively, if the question needs to be periodically updated, then the flow chart resets to 702 back to a default state.

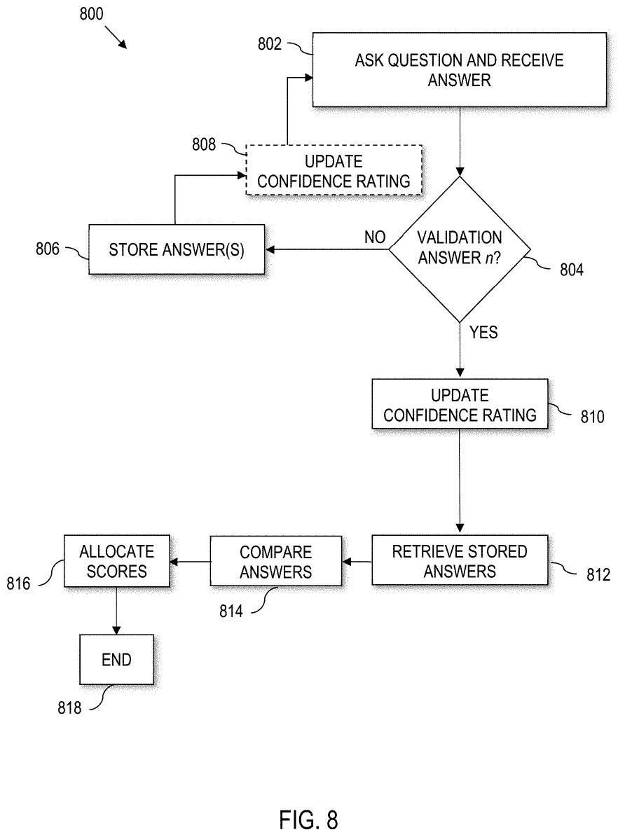

FIG. 8 illustrates an alternate flow chart 800 for comparing answers and scoring. In this example, a first user is presented a question, and the question is answered at 802. At 804 is a validation check threshold similar to that described above in flow chart 600. If the validation check threshold at 804 is not met, then at 806 the answer by the first user is stored and the flow chart 800 resets to 802. Optionally, a confidence rating of the data value from which the question is derived may be updated as shown at 808.

Once the validation check threshold at 804 is met, the confidence rating of the data value from which the question is derived is updated at 810, and the stored answers at 806 are retrieved at 812.

The retrieved answers are compared at 814 to determine which answer(s) is correct (e.g., based on averages, simple majority, threshold, etc.). Once the determination is made, scores are allocated at 816 to each user (i.e., positive scores for users that answered correctly, negative scores for users that answered incorrectly), and the flow chart ends at 818.

Reverification of Data Values

Various implementations herein are directed toward filling in data values or otherwise discovering information. However, filling in data values, depending on the industry may not be enough to provide a requisite amount of data validation and data integrity. In fact, in many instances, data within data values needs (or at least “should”) to be updated regularly. For instance, amount of virtual random access memory (VRAM) being used by a given program at a given time may need to be checked and updated weekly, daily, hourly, etc.

In the case of a device, wireless connections to a network can change day-to-day, hour-by-hour, etcetera. Thus, a one-time check is not sufficient. Conversely, a serial number of a particular device is not likely to change, thus a one-time check may be sufficient.

Accordingly, aspects of the present disclosure can accommodate the need for recurring checks of data values (e.g., after the process 300 has been completed). After a predetermined amount of time, the various processes herein may re-solicit (i.e., re-verify) data values within information profiles. In this regard, users that were solicited prior to fill in the data values may be solicited again. Alternatively, new users or third parties may be solicited.

A Process for User-Based Validation of Data Accuracy

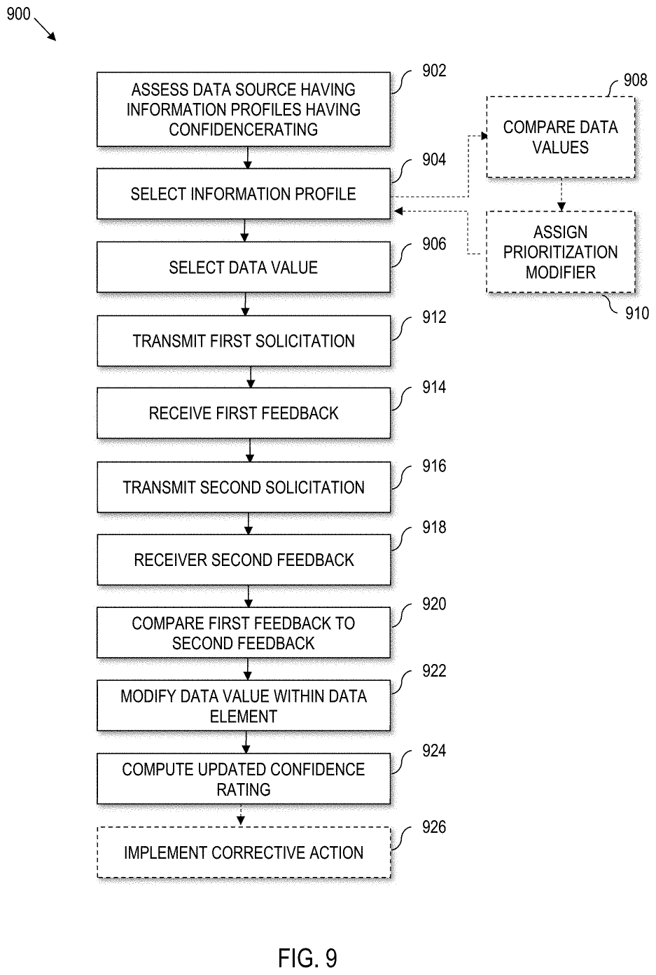

Now referring to the figures, and in particular FIG. 9, a process 900 for user-based validation of data accuracy is disclosed. All definitions, embodiments, etc. that are applicable to the process 300 are also applicable to the process 900. In this regard, not all definitions, embodiments, etc. need be used.

The process 900 comprises assessing at 902 a data source, the data source having a collection of information profiles, each information profile having a confidence rating assigned thereto, wherein the confidence rating characterizes a confidence in at least one of the completeness and accuracy of the data stored in the information profile (i.e., confidence rating is based on completeness of the information profile and/or accuracy of the data stored in the information profile). Confidence and confidence ratings are described in greater detail herein.

Further, the process 900 comprises selecting at 904 an information profile. In various embodiments, the information profile can be selected externally. For example, in various embodiments, the process 900 comprises selecting the information profile based on a received input from a user. For example, the user may wirelessly communicate with a device using a mobile device (e.g, Bluetooth). The user can then transmit the device (including its associated information profile and data values) to aspects of the process 900.

The process 900 also comprises selecting at 906 a data value within a data element from the information profile based upon the confidence rating of the selected information profile.

With respect to selecting 906 the data value, various embodiments of the process 900 comprise prioritizing at 906 an information profile (including the associated data value), wherein prioritizing an information profile comprises comparing at 908 data elements and associated data values of at least two information profiles within the collection of information profiles and assigning at 910 a prioritization modifier to at least one of the compared information profiles based on at least one of the calculated confidence rating, a completeness of the information profile, and a need-based modifier (i.e., based on the confidence rating, a completeness of the information profile instance, a need-based modifier, or a combination thereof).

Moreover, the process 900 comprises transmitting at 912 to a first processing unit (see reference number 102 in FIG. 1), a first solicitation for feedback, where the first solicitation is generated based upon a first requirement to update the selected information profile, and a second requirement to update the associated confidence rating.

Further, the process 900 comprises receiving at 914 the first feedback from the first processing unit, which is described in greater detail herein.

Yet further, the process 900 comprises transmitting at 916 to a second processing unit, a second solicitation for feedback, where the second solicitation is generated based upon the first requirement to update the selected information profile, and the second requirement to update the associated confidence rating.

Thus, in various embodiments, transmitting to the second processing unit a second solicitation for feedback comprises receiving a log-on from a second user from a second processing unit, wherein the second user has a second determined user role, selecting a data value from the information profile based on the second determined user role, selecting a second question that solicits an answer, which represents a value to be entered into the selected data value and transmitting the selected second question to a second graphic user interface of the second processing unit operated by the second user. In various embodiments, the first user and the second user do not know each other.

In addition, the process 900 comprises receiving at 918 feedback from the second processing unit.

Moreover, the process 900 comprises comparing at 920 the first feedback to the second feedback. In various embodiments, the process 900 solicits more than two feedback(s) for a higher degree of confidence, as well as enabling the process to use more complex comparison techniques.

In multiple embodiments, the feedback(s) are compared to find a common or consistent feedback (which indicates that the feedback is accurate or correct). Feedback can be compared using various mechanisms such as averages, simple majority, weighted based on the user that submitted the answer(s), or a combination thereof.

Still referring to FIG. 9, the process 900 comprises modifying at 922 the selected data value within a data element of the selected information profile, where there is agreement between the first feedback and the second feedback, with a data value derived from the first feedback and the second feedback.

In addition, the process 900 comprises computing at 924 an updated confidence rating based upon the first feedback and the second feedback. Once an agreement is reached, the data value is updated. If the data value was blank, the feedback will fill in the blank. If the data value had a pre-existing value, the pre-existing value is replaced.

In various embodiments, the process 900 may comprise implementing at 926 a corrective action when the first feedback and the second feedback do not agree. Corrective actions can include, but are not limited to issuing an alert to a pre-determined third party, quarantining the information profile, re-soliciting feedback, etc.

Cyclic Approach for User-Based Validation of Data Accuracy

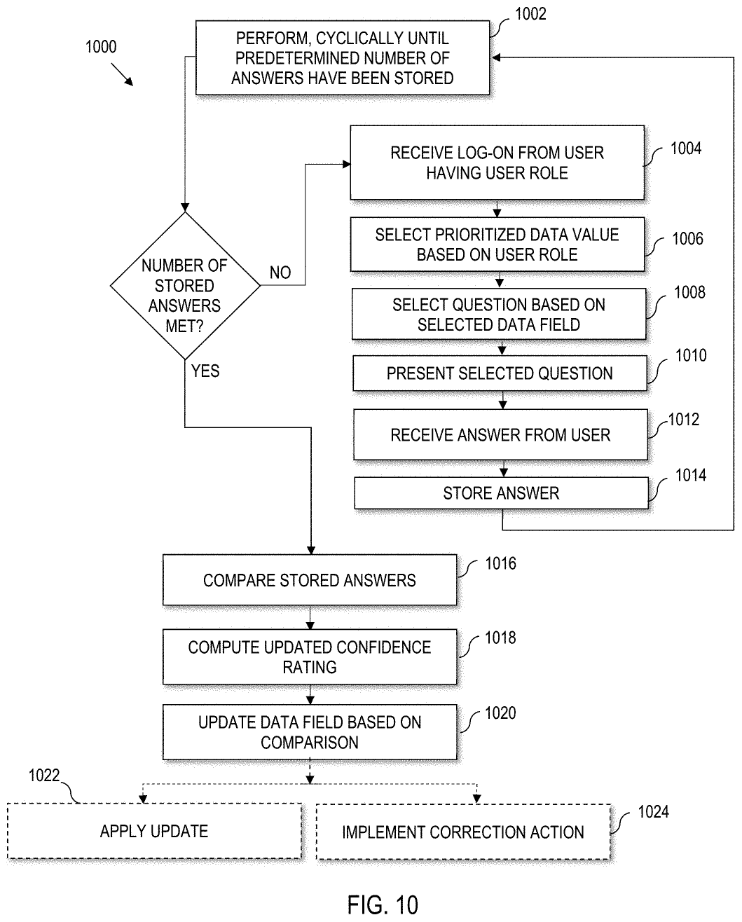

FIG. 10 illustrates a process 1000 for user-based validation of data accuracy.

The process 1000 comprises performing at 1002, cyclically until a predetermined number of answers have been stored, receiving at 1004 a log-on from a user from a device, wherein the user has a determined user role.

Further, the process 1000 comprises selecting at 1006 a data value from a prioritized information profile based on the determined user role. The prioritized information profile is an information profile that has been prioritized using the prioritization mechanisms already disclosed herein.

Moreover, the process 1000 comprises selecting at 1008 a question that solicits an answer, which represents a value to be entered into the selected data value.

In addition, the process 1000 comprises presenting at 1010 the selected question to a graphic user interface of the device operated by the user.

Further, the process 1000 comprises receiving at 1012 an answer to the question by the user.

Yet further, the process 1000 comprises storing at 1014 the answer.

Moreover, the process comprises comparing at 1016, upon reaching the predetermined number of answers, the stored answers against one another. Answers can be compared using various mechanisms such as averages, simple majority correlation, a majority with a minimum threshold, a weighted based comparison on the user that submitted the answer(s), or a combination thereof.

In addition, the process 1000 comprises computing at 1018 an updated confidence rating for the information profile.

Also, the process 1000 comprises updating at 1020 the information profile based on the comparison. In various embodiments, the process 1000 comprises applying 1022 an update to the device based on the updated information profile (e.g., a system patch). In further embodiments, the process 1000 comprises implementing at 1024 a correction action when the first feedback and the second feedback do not agree as disclosed herein. Moreover, the process 1000 may comprise re-validating the updated data value after a predetermined amount of time (i.e., repeat the questions, validations, etc.).

Miscellaneous

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects. Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, a portable computer diskette, a hard disk, a random access memory (RAM), a read-only memory (ROM), an erasable programmable read-only memory (EPROM), Flash memory, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device (e.g., a processor as illustrated in FIG. 8). A computer storage medium is not a transient propagating signal, as such.

A computer readable signal medium may include a propagated data signal with computer readable program code embodied therein, for example, in baseband or as part of a carrier wave. A computer readable signal medium is not a computer readable storage medium.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes and systems for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A process for user-based validation of data accuracy comprising:
assessing a data source, the data source having a collection of information profiles, each information profile having a confidence rating assigned thereto, wherein the confidence rating characterizes a confidence as completeness of stored data in the information profile and/or accuracy of stored data in the information profile;
selecting an information profile from the collection of information profiles;
transmitting to a first processing unit, a first solicitation for feedback, where the first solicitation is generated based upon:
a first requirement to update the selected information profile, and
a second requirement to update the associated confidence rating;
receiving the first feedback from the first processing unit;
transmitting to a second processing unit, a second solicitation for feedback, where the second solicitation is generated based upon:
the first requirement to update the selected information profile, and
the second requirement to update the associated confidence rating;
receiving the second feedback from the second processing unit;
comparing the first feedback to the second feedback;
modifying a data value within a data element of the selected information profile, where there is agreement between the first feedback and the second feedback, with a data value derived from the first feedback and the second feedback; and
computing an updated confidence rating based upon the first feedback and the second feedback.

2. The process of claim 1 further comprising prioritizing an information profile, wherein prioritizing an information profile comprises:
comparing data elements and associated data values of at least two information profiles within the collection of information profiles; and
assigning a prioritization modifier to at least one of the compared information profiles based on the confidence rating, a completeness of the information profile instance, a need-based modifier, or a combination thereof.

3. The process of claim 1, wherein selecting an information profile comprises:
delineating between product level information and asset level information data within the information profile, wherein product level information is comprised of non-modifiable data, and asset level information is comprised of modifiable data.

4. The process of claim 1 further comprising:
implementing a correction action when the first feedback and the second feedback do not agree.

5. The process of claim 1, wherein computing an updated confidence rating comprises:
computing the confidence rating based off of a completeness score, an update score, and a validation score.

6. The process of claim 1, wherein:
transmitting to a first processing unit, a first solicitation for feedback comprises:
receiving a log-on from a first user from a first processing unit, wherein the first user has a first determined user role;
selecting a data value from the information profile based on the first determined user role;
selecting a first question that solicits an answer, which represents a value to be entered into the selected data value; and
transmitting the selected first question to a first graphic user interface of the first processing unit operated by the first user; and
transmitting to a second processing unit, a second solicitation for feedback comprises:
receiving a log-on from a second user from a second processing unit, wherein the second user has a second determined user role;
selecting the data value from the information profile based on the second determined user role;
selecting a second question that solicits the answer, which represents the value to be entered into the selected data value; and
transmitting the selected second question to a second graphic user interface of the second processing unit operated by the second user.

7. The process of claim 1, wherein comparing the first feedback to the second feedback comprises:
comparing the first feedback to the second feedback against one another by an average, a simple majority correlation, a majority with a minimum threshold, a weight comparison based on the user that submitted the answer, or a combination thereof.

8. The process of claim 1, further comprising:
generating, for each information profile, a corresponding confidence rating.

9. The process of claim 1, where selecting an information profile comprises:
selecting the information profile based on a received input from a user.

10. The process of claim 1, wherein selecting a first question comprises:
accessing a user profile, which is associated with a user, from the user platform, wherein the user profile comprises a user role and a user rank;
comparing known values associated with the information profile against the user profile; and
filtering out questions that are determined to exceed a capability of the user based on the comparison.

11. The process of claim 1 further comprising:
retrieving a user baseline score from a user;
applying a positive score modifier to the user baseline score of the user if the first answer and the second answer are correct; and
applying a negative score modifier to the user baseline score of the user if the first answer and the second answer are incorrect.

12. A process for user-based validation of data accuracy comprising:
accessing a data source, the data source having a collection of information profiles, each information profile having a confidence rating assigned thereto, wherein the confidence rating characterizes a confidence as completeness of stored data in the information profile and/or accuracy of stored data in the information profile;
selecting an information profile from the collection of information profiles;
selecting a data value within a data element from the information profile based upon the confidence rating of the selected information profile;
transmitting to a first processing unit, a first solicitation for feedback, where the first solicitation is generated based upon the selected data value;
receiving the first feedback from the first processing unit;
transmitting to a second processing unit, a second solicitation for feedback, where the second solicitation is generated based upon the selected data value;
receiving the second feedback from the second processing unit;
comparing the first feedback to the second feedback;
modifying the selected data value, where there is agreement between the first feedback and the second feedback, with a data value derived from the first feedback and the second feedback; and
computing an updated confidence rating based upon the first feedback and the second feedback.

13. The process of claim 12 further comprising:
implementing a correction action when the first feedback and the second feedback do not agree.

14. The process of claim 12, wherein comparing the first feedback to the second feedback comprises:
comparing the first feedback to the second feedback against one another by an average, a simple majority correlation, a majority with a minimum threshold, a weighted comparison based on the user that submitted the answer, or a combination thereof.

15. The process of claim 12, where selecting an information profile comprises:
selecting the information profile based on a received input from a user.

16. A process for user-based validation of data accuracy comprising:
performing, cyclically until a predetermined number of answers have been stored:
receiving a log-on from a user from a device, wherein the user is associated with a determined user role;
selecting a data value from a prioritized information profile associated with a first device, based on the determined user role;
selecting a question that solicits an answer, which represents a value to be entered into the selected data value;
presenting the selected question to a graphic user interface of the device operated by the user;
receiving an answer to the question by the user; and
storing the answer;
comparing, upon reaching the predetermined number of answers, the stored answers against one another;
computing an updated confidence rating for the information profile; and
updating the information profile based on the comparison.

17. The process of claim 16 further comprising:
implementing a correction action when the first feedback and the second feedback do not agree.

18. The process of claim 16, wherein comparing the stored first answer against the stored second answer comprises:
comparing the stored first answer against the stored second answer by an average, a simple majority correlation, a majority with a minimum threshold, a weighted comparison based on the user that submitted the answer, or a combination thereof.

19. The process of claim 16 further comprising:
re-validating the updated data value after a predetermined amount of time.

20. The process of claim 16 further comprising:
applying an update to the device based on the updated information profile.
